(19) United States
(12) Patent Application Publication
(10) Pub. No.: US 2016/0349045 A1
(43) Pub. Date: Dec. 1, 2016

(54) A METHOD OF MEASUREMENT OF LINEAR DIMENSIONS OF THREE-DIMENSIONAL OBJECTS

(71) Applicant: Andrei Vladimirovich KLIMOV, Moscow (RU)

(72) Inventor: Andrei Vladimirovich KLIMOV, Moscow (RU)

(21) Appl. No.: 14/436,155

(22) PCT Filed: Dec. 19, 2014
(86) PCT No.: PCT/RU2014/000962

§ 371 Date: Apr. 16, 2015

(51) Int. Cl. G01B 11/25; G06T 17/20; H04N 13/02

(52) U.S. Cl. CPC G01B 11/25; H04N 13/0246; H04N 13/0282; G06T 17/20

(57) ABSTRACT

A method for performing three-dimensional measurements that includes: projecting with a projector of reset non-overlapping images oriented alone the one of longitudinal axis with a constant distance in between, registering the light from the projector reflected from the object using at least one camera placed with formation of a triangulation angle between the central beam of the projector and central beams of the cameras, the cameras are arranged at an angle to the projector as in the vertical and horizontal planes. Each of the images projected on the measured object is a discrete sequence of geometric elements, and the identification of images taken by the camera of these elements is made due to the projected shift. The method provides for reduced distortion of measurements for Y-axis and enhanced sensitivity for Z axis, mad almost complete elimination of errors i.e. improved accuracy at measurements.

### RELATED APPLICATIONS

This application is a National phase application from PCT application No. PCT/RU2014/000962 filed on Dec. 19, 2014.

### FIELD OF THE INVENTION

The invention relates to measuring equipment and can be used for 3D measurement with sufficient accuracy and visualization of three-dimensional profiles of objects by observing the projected pre-known pattern at different triangulation angles.

### PRIOR ART

There is a known method of measurement of linear dimensions of three-dimensional objects along three coordinate axes that includes forming on the surface of the measured object probing structured lighting by illuminating the surface of the measured with optical radiation, spatially modulated in intensity, recording the image of the structured lighting distorted by surface relief of the measured object; determination by digital electronic calculator of the height of the surface relief of the measured object based on distortion of the structure of probing lighting, and the other two coordinates based on position of distortions of the structured lighting in the recorded image (WO 99/58930).

The main disadvantage of this method is high error level due to the fact that, when illuminating the surface of the measured object with optical radiation modulated by a single coordinate with a transparency with a constant periodic structure, it is impossible to foresee or provide for any distortions of the pattern caused by different reflective properties of the surface and deep depressions, which cannot be identified without a prior information on the macrostructure of the surface of the measured object.

There is a known method and a device implementing it for measurement of linear dimensions of objects in three dimensional Cartesian coordinates. The method is that a system of multi-colored stripes created by spatial modulation of intensity of probing optical radiation along One coordinate axis is projected onto the object. The system of multi-colored stripes is periodic and creates a structured lighting. As a result, the whole part of the surface of the measured object within sight of the light detector and the distorted image of structured illumination overlaid on the surface are captured in the same image. Then dimensions of the object are determined based on the degree of distortion of the set of stripes at the image and position of stripes in Cartesian coordinate system (WO 00/70303).

The disadvantage of this method and devices implementing it is low precision due to inability to clearly interpret disruption in strips in the image due to distortion by surface relief of the measured object, or presence of open-end holes, or low value of the spectral reflectance index, depending on the color of portion of the surface of the measured object. If the measured object is a set of local components, like a set of turbine blades, application of this method for is reconstruction of topology of the object and subsequent measurement of its linear dimensions are impossible.

There is a known method of optical measurement of surface shapes including placing surface under illumination by a projection optical system and in the field of view of a recording device for imaging of said surface; projecting of a set of images with predetermined lighting structure by the projection optical system onto the measured surface; recording respective sets of images of the surface at an angle different from the angle of projection of the set of images and determination of the shape of the measured surface based on the recorded images. In this method, at least three alternating periodic distributions of light intensity are projected on the surface. These distributions are sets of stripes, the intensity of which varies in the cross direction in a sinusoidal manner, and said periodic distributions of light intensity are different in shift of these sets of stripes in a direction perpendicular to the stripes, by a controlled amount within a stripe treated. The captured images are processed to obtain preliminary phase distribution containing phases corresponding to the points on the surface. Furthermore, an additional light intensity is once projected to the surface, allowing determining the number of said strips of said set of strips for each point of the said surface. And additional image of the said surface is recorded with obtaining for each visible point of said surface of resultant phase distribution based on the image of the object illuminated with the initial phase distribution, and the image of the object illuminated by the additional light intensity distribution. And the result of said phase distribution is used to obtain absolute coordinates of said surface using pro-calibration data. Measurement using the above methods assumes that registration of image of each point of the surface occurs in an environment where this point is illuminated with direct light from the projector, and illumination of image of an object point captured by the detector is considered proportional to the brightness of the beam falling on this point directly from the projector (RU no. 2148793).

The disadvantages of this method are complexity of its implementation and long duration of the process, requiring considerable time for measurements and leading to occurrence of errors due to mechanical vibrations of projector and camera equipment.

There is a known method and a device for non-contact measurement and recognition of surfaces of three-dimensional objects by means of structured illumination, including a source of optical radiation and a set of transparencies positioned in a sequence along the radiation beam, configured to generate aperiodic line structure of strips, afocal optical system for projecting transparency images to the measured surface, a receiving lens forming the image of the line structure occurring on the surface of the measured object and distorted by the surface relief of the measured object, a light detector that converts the image generated by the receiving lens to a digital form, and a digital electronic computing unit that converts the digital images recorded by light detector into coordinate values of the measured surface. This device is provided with an additional N−1 light sources, each of which is different from the rest in spectral range of radiation, N−1 transparencies, each of which differs from the others for at least one strip, N−1 receiving lenses installed behind the transparencies, N−1 mirrors set at 45 angular degrees to the optical axis of each of N−1 lenses before the second component of the afocal optical system, another N-1 mirrors installed behind the receiving lens at the angle of 45 angular degrees to the optical axis of the receiving lens, N−1 secondary receiving lenses, each of which is installed behind each of the secondary N−1 mirrors and together with the receiving lens, generates an image of line structure formed on the surface of the measured object and distorted by the surface relief of the measured object, N−1 light detectors, each of which has a spectral sensitivity region coinciding with a spectral range of radiation from N−1 radiation source, N−1 digital electronic computing units, where the image combining electronic unit has a number of inputs equal to the number of digital electronic computing units, and each of inputs of the image combining electronic unit is connected to the output of each digital electronic computing unit, and the number N is determined by the formula N=Log2 (L), where L is the number of pairs of elements of the spatial resolution of the light detector (RU no. 2199718).

The disadvantages of this method are complexity of its implementation and long duration of the process, requiring considerable time for measurements and is leading to occurrence of errors due to mechanical vibrations of projector and camera equipment.

There is a known method (and a device for its implementation) of 3D measurement using structured light. This method uses a projector to project to the investigated object a known image having at least two non-intersecting continuous lines along one of the longitudinal axes. The light reflected from the object is captured with at least two cameras placed at different distances from the projector with the formation of different triangulation angles between the central beam of the projector and the central rays of the cameras. After that, every continuous line projected by the projector and formed by reflected light captured by each camera is identified by comparing the coordinates of lines captured by cameras, where the triangulation angle between the central beam of the projector and the central beam of the first camera located at as minimum distance from the projector is equal to the arctangent function of ratio between the distance between the projected lines to a depth of field of the lens of the camera. After that, it is possible to identify in the image of the first camera the longitudinal coordinates of centers of the lines and vertical coordinates, as the quotient obtained by division of the longitudinal coordinate by the tangent of the triangulation angle between the central beam of the projector and the central beam of the first camera. In order to define its vertical position more precisely, the value obtained by the second camera is used. The second camera is located at the greater triangulation angle than the first. In order to obtain more precise value, positions of the same line are identified in the image received from the second camera, being closest to the longitudinal coordinates calculated as the product of said vertical coordinates defined by the first camera, the triangulation angle of the tangent of the second camera, and then determined for these lines is specified value of the longitudinal and vertical coordinates (PCT/RU2012/000909 Publication WO2014074003, prototype).

The disadvantage of this method is non-uniformity of measurements obtained along the Y-axis, insufficient sensitivity along the Z-axis, resulting in a possibility of significant error of measurement, especially in small objects. These drawbacks are due to the filet that when continuous solid lines are projected on the object, these lines are projected with a certain period in between, resulting in non is uniformity of measurements obtained along the Y-axis. Moreover, this method does not use the area of detector or camera receiver efficiently, and sensitivity of the 3D scanner is limited along the Z-axis. In this respect, measurements along the Y-axis are obtained with some spacing, typically every 5-10 pixels in the camera image, and for the X-axis measurements can be obtained in each pixel through which the line passes. In other words, the resolution along the X-axis is 5-10 times higher than along the Y-axis. Also, when constructing a three-dimensional surface in the form of a polygon mesh (of polygons 20 in FIG. 2) usually the equal distance is used in the measurements along the X and Y axes. For the Y-axis this distance is defined. by the distance between the projected continuous lines, and for the X-axis it is chosen to be of the same length, i.e. every pixel crossed by the line 21 stays unused. As a result, there is a redundancy in measurements at the X-axis that is not used in calculation of the surface, i.e. not all the pixels on the sensor and measurements made with these pixels are used for further calculations. When projecting images as continuous solid lines the camera is positioned at some angle to the vertical plane and in this case the Z coordinate is contained in the value of shift along the Y-axis, i.e. all points on the continuous straight lines are shifted by a small amount along the Y-axis and the angle between the camera and the projector can be selected sufficient to avoid any intersecting of possible positions of the solid lines with other possible positions of other solid lines, i.e. shill along the Y-axis would not exceed the period Ty along the Y-axis.

### SUMMARY OF THE INVENTIONS

The purpose of the invention is to provide an efficient and convenient method of measurement of linear dimensions of three-dimensional objects, as well as expand the range of methods of measurement of linear dimensions of three-dimensional objects.

The technical result providing solution of the problem in question consists in reduced distortion of measurements for Y-axis and enhanced sensitivity for Z axis, and almost complete elimination of errors, i.e. improved accuracy of measurements.

The essence of the invention is the method of performing three-dimensional measurements that includes: projecting with a projector of preset non-overlapping images oriented along the one of longitudinal axis with a constant distance in between, registering the light from the projector reflected from the object using at least one camera placed with formation of a triangulation angle between the central beam of the projector and central beams of the cameras, and then producing identification images projected b the projector and formed by the reflected light received by the camera, and the triangulation angle between the central beam of the projector and the central beam of the camera is selected to be equal to arctangent function of the ratio of the distance between the projected images to a depth of field of the camera lens, determining at the camera image the longitudinal coordinates of centers of the images and vertical coordinates as the quotient of the longitudinal coordinate divided by tangent function of the triangulation angle between the central beam of projector and the central beam of the first camera, at that each of the images that are projected b the projector onto the measured object is a discrete sequence of geometric elements, evenly spaced along a linear path parallel to the path of another image, and identification of images projected by the projector and formed by the reflected light received by the camera is provided by identifying a fragment of shift of each of the projected geometric elements, while the light of the projector reflected by the object is recorded by at least one camera placed at an angle to the projector in both the vertical and horizontal planes.

in general practice, the following figures are used as a discrete sequence of image elements to be projected: dots, dashes, strokes, intervals between geometric elements.

As a preferable option, the distance between the camera and the projector is chosen as the product of the distance from the projector to the point of intersection of the central beam of the projector and the camera by the tangent function of the triangulation angle between the central beam of the projector and the central beam of the camera.

As a preferable option, the light reflected from the object is registered by at least one additional improving camera, and the first camera and the improving camera are installed at different distances from the projector with formation of is different triangulation angles between the central beam of the projector and central beams of the cameras, and an improvement of the vertical coordinate is performed. The method uses the value of the vertical coordinate obtained by the improved camera positioned under the triangulation angle larger than the first camera. In order to achieve his, locations of the same geometric elements are identified on the improving camera image, being closest to the longitudinal coordinates calculated as the product of said vertical coordinates defined by the first camera by the tangent of the angle of triangulation the of the improving camera. After that, the improved values of the longitudinal and vertical coordinates are determined for these geometric elements.

As a preferable option, the reflected light is additionally recorded by two additional improving cameras.

In particular cases, these cameras can be placed on one side of the projector or on both sides of the projector.

As a preferable option, the additional texture of the object is recorded with an additional color camera, and the image capture with it is displayed on a computer screen and is overlaid with an image of three-dimensional polygon mesh obtained by calculation based on the light reflected by the object and captured by first camera and improvement with at least one improving camera.

In this case, measurement and determination of coordinates, as well as drawing of a three-dimensional polygon mesh are carried out with the help of an additionally installed computer, and the 3D image is formed on a computer screen. Transmission of measurements is performed by means of additional means of wireless communication of the following: Bluetooth, Wi-Fi, NFC.

### SHORT DESCRIPTION OF DRAWINGS

FIG. 1 shows a diagram of positions of the projector and the camera in the scanning system when projecting images in the form of dots on the object.

FIG. 2 shows a pattern of dots at the projected (initial) image created by the projector.

FIG. 3 shows the image received by the camera.

FIG. 4 shows the shift lengths of dots in the received image obtained from different cameras.

FIG. 5 shows the possible images that can be projected using the projector.

FIG. 6 shows the proposed location of the two cameras, projector and color camera;

FIG. 7 shows three possible arrangements of cameras, projector and color camera.

FIG. 8 shows a proposed arrangement of a 3D scanner, in

FIG. 9 is a block diagram showing the sequence of scanning of an object and a sequence of processing of an image using a computer.

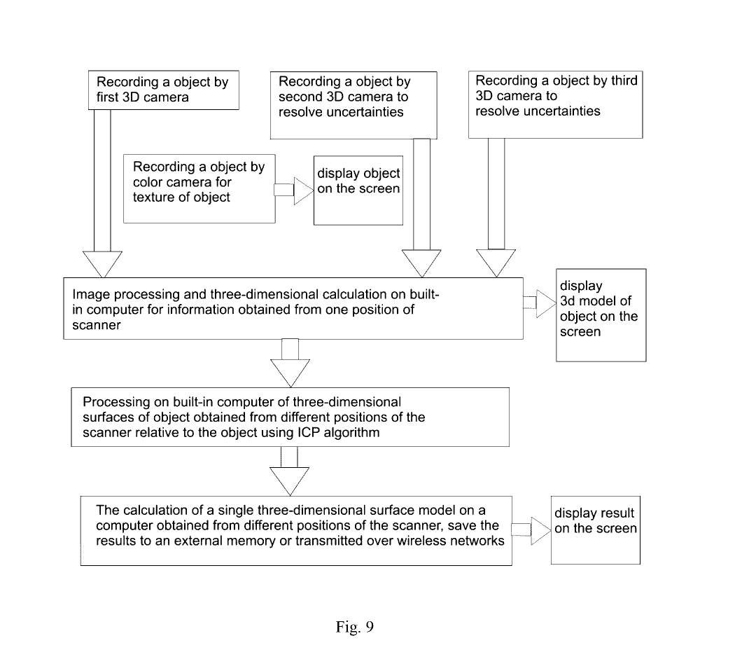

FIG. 10 is a connection diagram for connection of elements inside the scanner and an example of positioning of a measured object during implementation of the method.

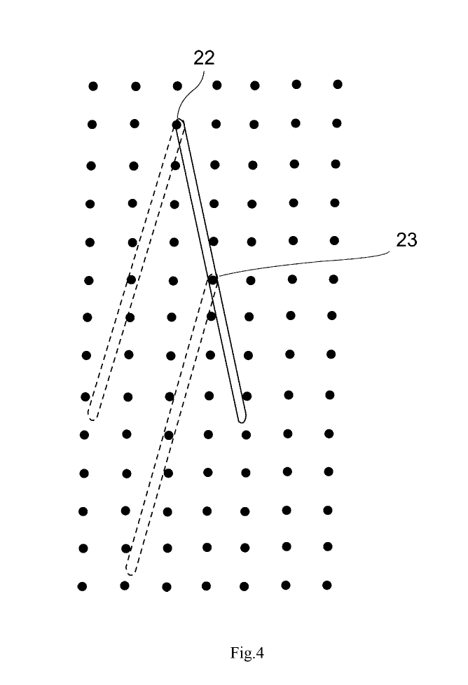

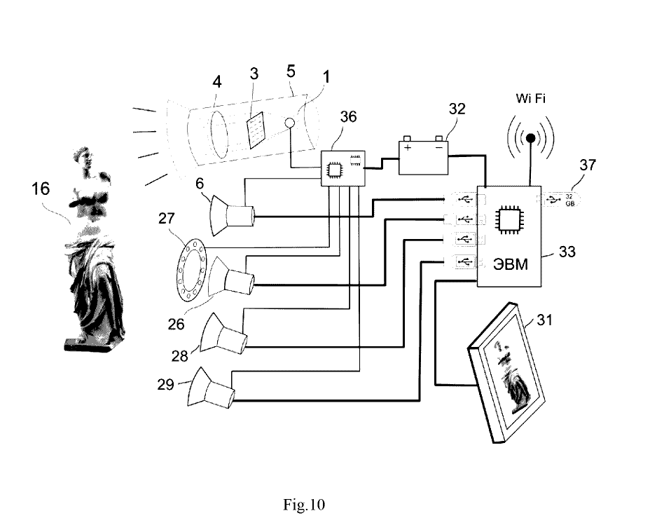

In the drawings, the following parts are indicated with numbers: radiation source 1; condenser lens 2; transparency 3 with the projected image of geometric elements, such as dots 8 and 9; lens 4 of the projector 5 and lens 4 of the camera 6; projector 5; scanning area 7 of the object 16; projected dots 8 and 9; central beam 10 of the projector 5; central beam 11 of the camera. receiving array 12 of the camera 6; far plane 13 of the object 16; nearest plane 14 of the object 16; median plane 15 of the object 16; shift length 17 for the dot 8; shift length 18 for the dot 8; object 16, on which the dotted image is projected, shift length 19 for the dot 8 for the location of the camera 6 shifted with respect to the projector 5 only in the vertical plane; polygons 20 for construction of the polygonal mesh; projected line 21; dots 22, 23 with intersecting shift lengths (FIG. 4); gaps (intervals) 24 in the projected paths which can be used as dots; strokes 25 in the projected paths, which can be used in a similar manner to dots; projector 5 in a front view; camera 6 closest to the projector 5 for construction of 3D images of the object 16; color camera 26 for capturing color images of the object 16; circular flash 27 for capturing high-quality texture of the object 16; improving camera 28 for construction of 3D images; the second improving camera 29 for construction of 3D images; housing of the scanner 30; display 31; battery 32, computer 33; optical mount 34; handle 35 for holding the scanner 30, control unit 36 to control the timing of cameras 6, 26, 28, 29 and light sources of the projector 5; removable external storage device 37 for data storing. As a preferable option, the projector 5, camera 6, computer 33 and display 31 as well as the rest of the device above equipment shall be housed in a common housing of the scanner 10 (the device is functionally represents a 3D scanner). 3D scanner device is a single-piece mobile 3D scanner 30, and its components including the projector 5, cameras 6, 26, 28, 29, computer 33 and monitor 31 are installed in a common housing provided with a handle 35. Transparency 3 (other terms: frame, slide, etc.), for example, a thin plate having different absorptive capacity or refractive index at various points in the plane under the light beam from the light source 1. Passage of a plane light wave through a transparency leads to amplitude or phase modulation of the signal at the output of the transparency.

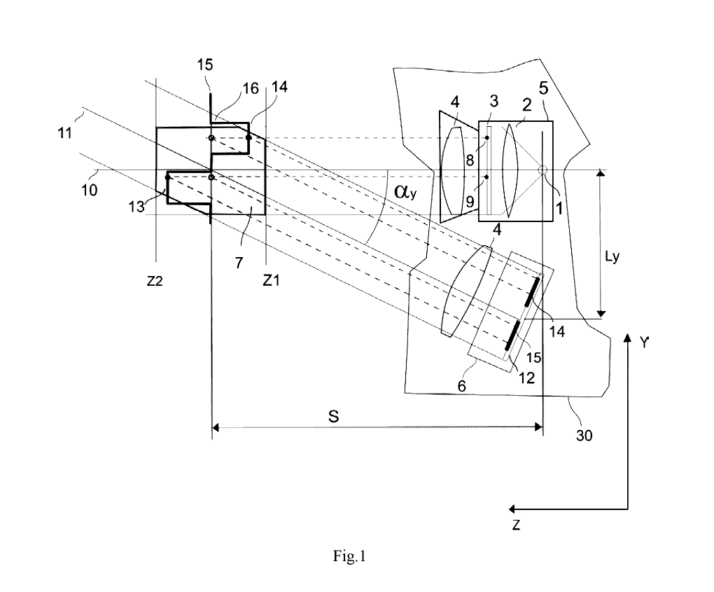

Display 31 of the scanner 30 is directed toward the user. FIG. 1 shows a structure drawing of 3D scanner 30 consisting of the projector 5 and camera 6. The projector 5 includes the light source 1, condenser lens 2, a transparency 3 with projected image of dots 7 and 8, and a lens 4 which projects the image of the transparency 3 on the object 16. The camera 6 includes receiving array 12 and camera lens 4, 6, which projects the image of the object 16 onto the receiving array 12 of the camera. Scanner 30 includes a battery 32 for supplying the computer 33, cameras 6, 26, 28, 29 and projector 5, and includes a wireless communication unit of the following types: Bluetooth, Wi-Fi, NFC for wireless data transfer to other communication devices, and a connector for external removable storage devices for storing and transferring data to another computer (PC).

### DETAILED DESCRIPTION OF THE INVENTION

A method for measurement of linear dimensions of three-dimensional objects is as follows.

Each image projected by the projector consists of periodically (uniformly) projected discrete elements: dots, dashes (similarly, segments of the image) or intervals between these elements along an imaginary straight path (imaginary straight line). These elements are arranged with a spacing Tx along the X-axis of the image and the spacing Ty along the Y-axis.

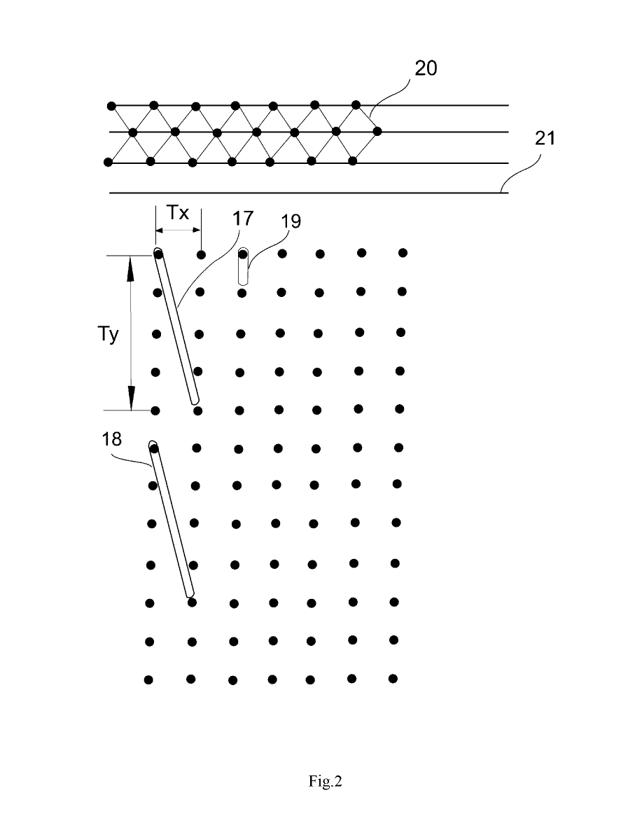

In the proposed method, when projecting images in a sequence (along two non-intersecting paths) of projected discrete geometric elements such as dots, and position of the camera 6 at an angle to the projector 5, not only in the vertical plane, but also in the horizontal one, can be used to increase the used shill length 17, i.e. the value of a possible shift of the dot 8 until it crosses the possible adjacent shift lengths, i.e. positions of other dots in the FIG. 2. Thus, when projecting an image to the object 16 as a sequence of discrete elements, for example dots, it is possible to use the area of receiving array 12 of the camera 6 more uniformly and efficiently and increase the sensitivity of the 3D scanner 30 along the Z-axis, as Z coordinate is contained in the possible shift of the dot 8 in the shift length 17 in the receiving array 12 of the camera 6. it can be seen on Future 2 how a. shift length 17 of a possible shift of a dot passes through the area on the receiving array 12, i.e., uses an area in the receiving array 12 that typically is occupied with the projected path elements and the shift length. Also in FIG. 2 it can be observed how much the possible shift length 17 is greater than the shift length 19.

For 3D scanner 30 in FIG. 1 the working area 7 is given in depth, i.e. for the Z-axis. The working area corresponds to the depth of field of the lens. The depth of field of the lens may be a reference value of the camera lens (the nominal value indicated in the camera's technical data sheet).

Depth of field of the camera lens Tz in each particular case can be determined for example, as: Tz=2DC/(f/S)²

where D is the area of camera aperture (m²), C is the size of a pixel in the camera (m), f is the focal length of the camera lens (m), S is the distance from the projector 5 to the point intersection of the central beams 11, 10 of the projector 5 and camera 6 (m).

Coordinates Z1 and Z2 are the boundaries of the working area. In this working area, the object 16 is measured by three coordinates. It is assumed that the scanner 30 does not make any measurements outside this area. Working area usually looks geometrically as a spatial region with intersection of beams from the projector 5 that forms the image and the beams limiting the field of view of the camera 6. In order to increase the working area in depth, it is allowed to include an area in which at close range the camera 6 can capture the object 16 only partially, and at long range the projector 5 could not light the entire surface of the object 16 to be captured by the camera 6. The point of intersection of the central beam 11 of the optical system of the camera 6 and the central beam of the optical system of the projector 5 is located in the middle of the working area. Focusing: distance from the light source 1 of the scanner 30 to the mid-line of the area indicated in FIG. 1 with letter S, this distance is typically used for focusing lenses of the camera 6 and the projector 5. The images drawn on the transparency 3 is projected by the projector 5 on the object 16.

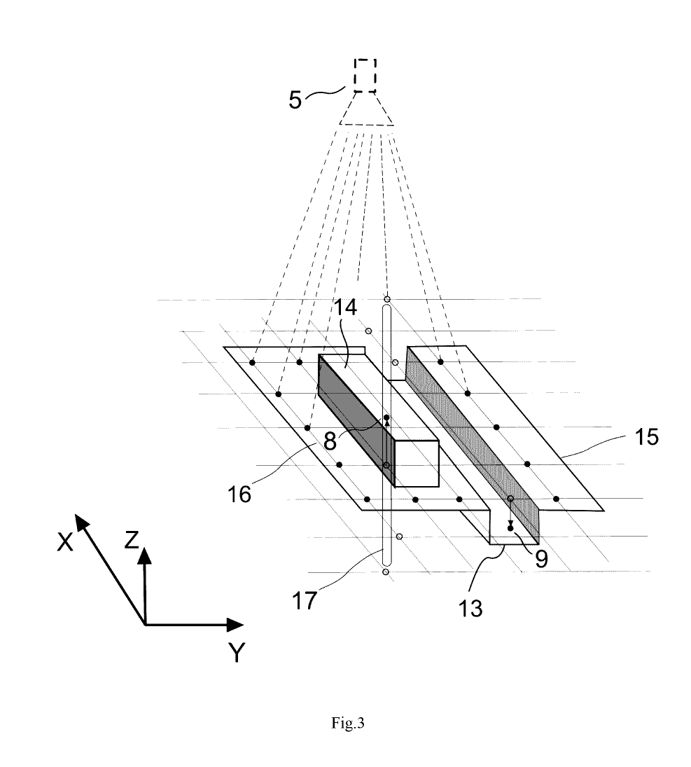

The object 16 is shown in FIG. 1 as a section, and in FIG. 3 the object 16 is shown in an isometric view. Object 16 is composed of three parts, or planes. The median plane 15 passes through the point of intersection of the central beam 11 of the optical system of the camera 6 and the central beam 10 of the projector 5 at the focusing distance S (indicated in FIG. 1) from the scanner 30, the plane 13 is located at a greater distance from the scanner 30 than the median plane 15, and the plane 14 is closer to the scanner 30 than the median plane 15.

The projected images of the dots 8 and 9 can be seen on the receiving array 12 of the camera 6. Depending on the distance between the scanner 30 and one or another part of the object, dots 8 and 9 may be captured by different pixels of the receiving array 12 of the camera. For example, if we project a dot 8 at the object 16, we will observe the dot 8 at different locations on the receiving array 12 of the camera 6 in dependence on which plane the dot will be reflected: the median plane 15 or the plane 14. Areas on the receiver array 12 to which the dots 8, 9 can be projected the shift length 17, 18 of these dots.

Before scanning the object 16, calibration of the scanner 30 must be performed. During calibration, the system can be positioned in place, all the possible positions of the dots to be recorded and compated, i.e. recording individual dot shift length 8, 9 on an image obtained from the camera 6 to select the optimal distance to the object 16. This information is subsequently used when working with the object 16. For this purpose a plane (e.g. screen) is installed in front of the system consisting of the camera 6 and the projector 5 perpendicular to the optical axis of the projector 5 or the camera 6, and this screen is moved along the axis of the projector 5 or camera 6. Movement of the screen plane is provided by high-precision handling equipment, such as numerically controlled machine tool that allows obtaining coordinates with high accuracy of a few microns due to high-precision handling. This process includes recording the dependence of the is shift or shift length for dots in the image of the camera 6 depending on the distance from the scanner 30 including the camera 5 and the projector 6. This calibration process also takes into account the distortion (violation of geometric similarity between the object and its image) and other distortions of lenses of the camera 6 and the projector 5.

In the two-dimensional case, the dot shift length 19 in the image would look like the shift length shown in FIG. 2.

In order to accurately measure object 16 in three coordinates, it is necessary that the shift length 17, 18 do not overlap in the image created by the camera 6, regardless of where the object 16 or part of the object 16 are in the working area of the scanner 30. To fulfill this condition, it is necessary to choose right spacing distances Tx and Ty between the dots along the X and Y axes of positions of the dots in the image projector 5, and angles and base distance between the projector 5 and the camera 6 along the X and Y axes. These options can he selected using the correlations tg αy=Ty/z1−z2, tgαx=Tx/z1−z2. Basic distances Ly=S*tg αy and Lx=S*tg αx

Where S is the focusing distance from the light source 1 of the scanner 30 to the mid-line of the area or the distance from the light source 1 of the scanner 30 to the intersection of the central beams 10, 11 of the camera 6 and the projector 5.

FIG. 2 shows that if the camera 6 is positioned directly below the projector 5, i.e. if the angle αx is 0, then the dot shift length 19 is shorter than the dot shift length 17. It follows that it is more efficient to position the camera 6 under the angle αy and αx to the projector 5, i.e. camera 6 should be placed at an angle to the projector 5 not only in a vertical plane but also in a horizontal one. Due to this arrangement of the camera 6 relative to the projector 5 it is possible to measure the Z coordinate more accurately, as the shift length 17 of a dot is longer in the same area and more pixels correspond to the image of the camera 6 for the shift length 17, i.e., it is possible to make more measurements using the receiving array 12 of the camera 6 for the same area along the Z axis.

FIG. 3 shows the image observed by the camera 6 with the view from the camera 6. The projector 5 projects the image consisting of dots on the object 16, and the camera 6 is located at the angle αy and the angle αx to the X and Y axes. In FIG. 3 it is possible (for illustration purposes) to observe the grid in the nodes of which dots are located. This grid corresponds to the position of the points that would exist if the object 16 consists only of the median plane 15. For example, the dot 8 is caught in the plane 14 which is closer to the projector 5 than the median plane 15, so it is moved above at the camera image 6. The shift of the dot is drawn with the arrow 8 in FIG. 3. Possible (punctured) position of the dot 8 in the case of a continuous plane 15 of the object 16, i.e., the estimated position that would be possible if the dot is projected on the median plane 15 and is at the beginning of the small arrow at the diagram, and the position of the dot reflected from the plane 14 is at the end of the arrow. It is also possible to observe the shift of the dot 9, which is projected on the plane 13. For the dot 8, there is a shift length 17 along which it can move. It can be seen in FIG. 3 that the point 8 may take any position on the shill length 17 and thus will not cross with the possible shift lengths and positions of other points.

To increase the dot density and thereby the accuracy of measurement of small sized items, it is possible to use a second camera 28 positioned at another angle relative to the projector 5, different from the angle of the first camera 6. In this way it is possible to increase, for example, the density of the dots twofold, and shift length of dots will intersect, but the second camera 28 will allow resolving the uncertainty in the points of intersection. FIG. 4 shows the points 22 and 23 with the shift lengths intersecting the in the image of the same camera 6, but this uncertainty can be resolved by using the image with the second camera 28, which is positioned at the angle −αx to the projector 5, i.e. with opposite sign than the first camera 6, and shift lengths shown with dotted lines in the FIG. 4 do not intersect for these two points in the second camera 28. For greater increase in the density of the slide a third camera 29 can be used to test and improve the positions of found dots, and a color camera 26 to capture the texture of surface of the object 16, located between the projector 5 and the camera 28 farthest from the projector 5.

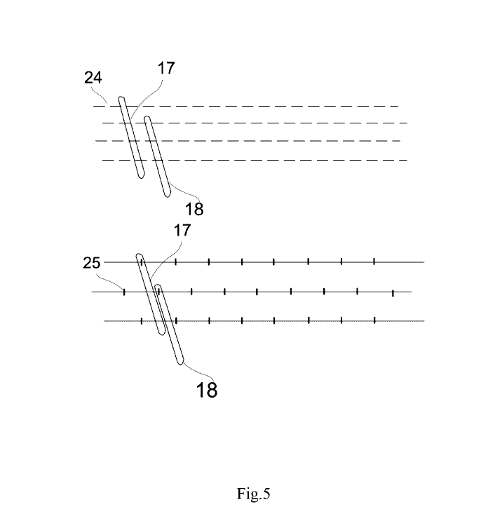

It is possible to produce an image that is projected by the projector 5 with strokes or stripes (lines), between which light dots 24 are arranged, as shown in FIG. 5. Points can be dark if the picture is negative. These points appear as gaps in the lines of paths. It is possible to produce an image with stripes crossed with vertical lines 25. These strokes 25 or gaps in the line paths are shifted in the image from the camera 6 similar to dots described above. In order to understand which section in the image from the camera 6 and which number of the period are correspond to each other, it is necessary need to follow along the shift length to the right or to the left until the next break or stroke and to determine the period by its position at the shift length 17 or 18.

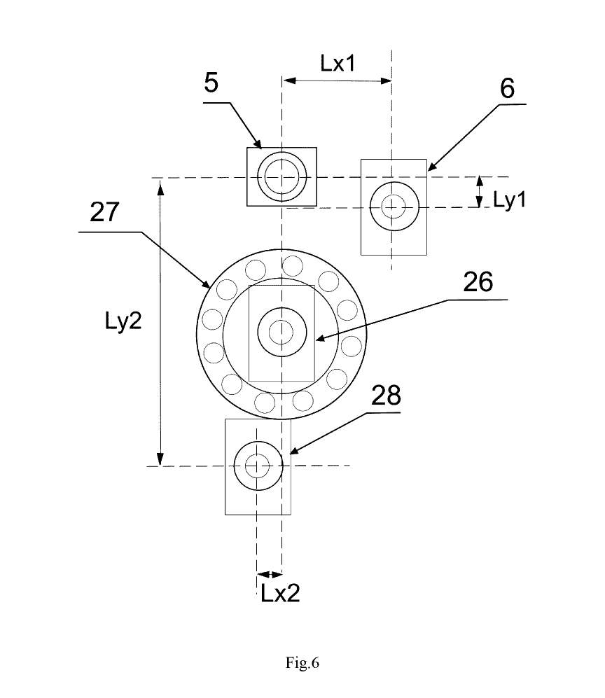

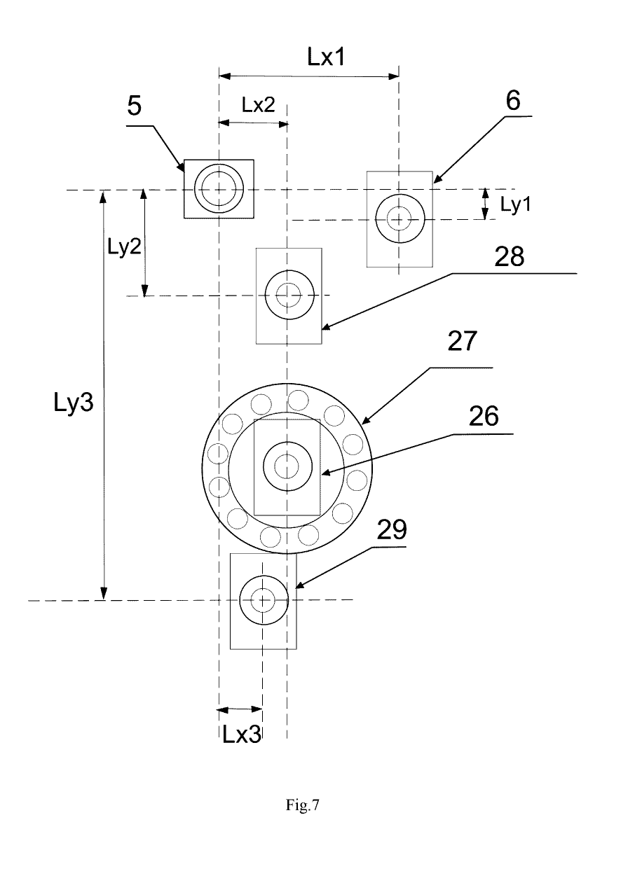

Proposed layout diagrams for the cameras 6, 26, 28, 29 and the projector 5 in the scanner 30 are shown in FIGS. 6 and 7. It can be seen that for each camera 5, 26, 28, 29 there are base distances along the X and Y axes, i.e. there are different angles between each central beam of the cameras 25, 26, 28, 29 and the central beam of the projector 5 in two planes, horizontal and vertical.

Camera 26 does not capture the image projected by the projector 5. but captures the texture, i.e. colors of the object 16. The light source in the projector 5 can be of pulsed type and pulse period can be a fraction of a second The camera 26 captures the texture with a time delay of a few fractions of a second and does not capture the light from the source of the projector 5. In order to obtain a quality color image of the object 16, a circular flash 27 is installed around the camera 26, being made of pulsed white light sources which are also triggered in sync with the camera 26, i.e., with a certain delay relative to the light source of the projector 5. Synchronization of cameras 6, 26, 28, 29 and light sources of the projector 5, as well as their delay values are controlled with the controller 36.

FIG. 6 shows a proposed diagram of the 3d scanner 30, front view, with two cameras 6 and 28, images from which are used to calculate the 3D image.

FIG. 7 shows a proposed diagram of the 3d scanner 30, front view, with three cameras 6, 28 and 29, images from which are used to calculate the 3D image.

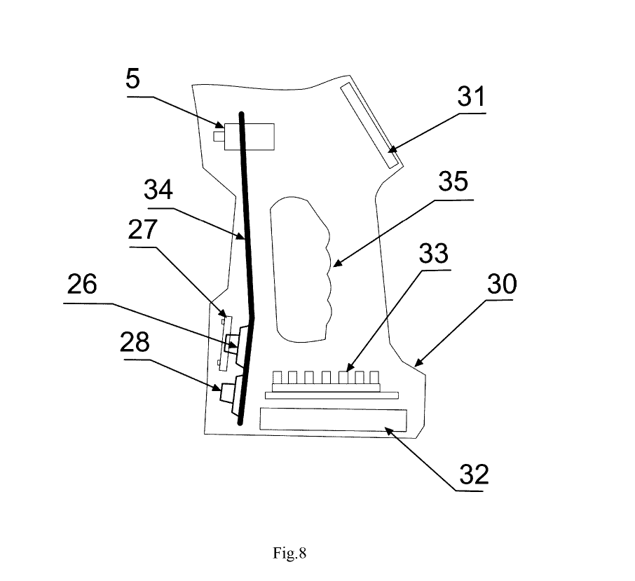

FIG. 8 shows a structural diagram of the device (3D scanner 30) in as side view, including the housing 30 provided with the handle 35 that allows the user to hold the scanner 30 in hand in a comfortable manner. The user can observe the is process of scanning using the display 31 of the scanner 30. The display 31 of the scanner 30 displays an image captured by the color camera 26 in order for the user to understand which part of the object 16 is in the field of view of the camera 26, and the image is overlaid with another image of three-dimensional polygonal tries h calculated using the built-in computer 33 on the basis of processed images from cameras 6, 28 and 29. This is necessary for the user to understand what part of the object 16 he had measured using the 3D scanner 30.

Each polygonal 3d surface is recorded with the built-in computer 33 in the coordinate system of the object 16 using the ICP algorithm.

The projector 5 and cameras 6, 26, 28 and 29 are rigidly fixed to the optical mount 34. Optical mount 34 should be made of a sufficiently durable material such as aluminum or steel, which has a relatively low coefficient of linear expansion, as preserving the mutual position of the cameras 6, 26, 28 and 29 with respect to the projector 5 is very important and influences the accuracy of scanning of surface. This position is measured during the calibration of the device (scanner 30). Any small micron-sized movement of the cameras 6, 26, 28, 29 with respect to the projector 5 could lead to distortion of measurements, which are measured in millimeters. During scanning at the stage of recording of strikes in the coordinate system of the object using an ICP algorithm, errors resulting from movements of the cameras 6, 26, 28, 29 are summed for each surface, and it can lead to centimeter-sized distortions of measurements of the object 16.

Saving and transmission of data can be performed through a connector for connecting external removable storage devices. Furthermore, a wireless communication unit from the following group: Bluetooth, Wi-Fi, NFC, provides, if necessary, wireless transmission of data to another computer (PC).

To carry out the measurements using the proposed method and the scanner 30, the scanner must be taken into hands, the measured object 16 placed in the field of view of the cameras 6, 26, 26, 29, so that it can be observed on the screen 31, as the color image from the camera 26 is immediately (without processing) displayed on the display 31. This is followed by positioning of the measured object 16 at the correct distance from the scanner 30, i.e. so that it was in the working area 7. During operation of the scanner 30, the projector 5 projects the image of the transparency 3 on the object. The camera 6 captures the reflected light and records the image of the illuminated object 16. Then the built-in computer 33 processes the image captured by the camera 6. If there are any ambiguities or uncertainties in the calculation, then the program uses images obtained from cameras 28 and 29 to improve and check the position of elements of projected image of the transparency 3. After processing the images from cameras 6, 26, 28, 29, the computer 33 displays on display 31 a calculated image of a 3D model of the object 16 with the calculated dimensions. If necessary, the user can walk around the object 16 with the scanner 30 in hand, constantly keeping the object 16 m the work area 7 of the scanner 30 and receiving images of the object 16 with different angles or different positions of the scanner relative to the object. Computer 33 processes the images obtained from cameras 6, 28, 29 at each angle and uses ICP algorithm to put new 3D models into the coordinate system of the first 3D model obtained. As the result, the user obtains a 3D model of the object 16 with calculation of its dimensions, i.e. the user receives a 3D measurement of the object 16 from all sides.

Therefore, the proposed method provides an increased uniformity of the obtained measurement along the Y-axis, increased sensitivity along the Z-axis, and almost complete elimination of errors, i.e. improving the accuracy of measurements and allowing creation of a single-piece mobile device (3D scanner) for implementation of this method.

### INDUSTRIAL APPLICATIONS

The present invention is embodied with multipurpose equipment extensively employed by the industry.

The following ICP algorithms were used:

[1] Besl, P. and McKay, N. “A Method for Registration of 3-D Shapes,” Trans. PAMI, Vol. 14, No. 2, 1992

[2] Chen, Y. and Medioni, G. “Object Modeling by Registration of Multiple Range Images,” Proc. IEEE Cont: on Robotics and Automation, 1991

[3] RUSINKIEWICZ, S., AND LEVOY, M. 2001. Efficient variants of the ICP algorithm. In Proc. of 3DIM, 145-152.

1. A method for three-dimensional measurement of an object, comprising: projecting with a projector a preset of non-overlapping images oriented along one of longitudinal axis with a constant distance in between, s registering a light from the projector reflected from the object using at least one camera placed with formation of a triangulation angle between a central beam of the projector and central beams of the cameras, and then producing identification images projected by the projector and formed by the reflected light received by the camera, and the triangulation angle between the central beam of the projector and a central beam of as first camera is selected to be equal to arctangent function of a ratio of a distance between the projected images to a depth of field of a camera lens; determining at a camera image—longitudinal coordinates of centers of the images and vertical coordinates as a quotient of a longitudinal coordinate divided by tangent function of the triangulation angle between the central beam of projector is and the central beam of the first camera, wherein each of the images that are projected by the projector onto the measured object is a discrete sequence of geometric elements, evenly spaced along a linear path parallel in as path of another image, and an identification of images projected by the projector and formed by the reflected light received by the camera is provided by identifying a fragment of shift of each of the projected geometric elements, while the light of the projector reflected by the object is recorded by at least one camera placed at an angle to the projector in both the vertical and horizontal planes.

2. The method of claim 1, wherein the following figures are used as a discrete sequence of image elements to be projected: dots, dashes, strokes, intervals between geometric elements.

3. The method of claim 1, wherein a distance between the camera and the projector is chosen as a product of a distance from the projector to a point of intersection of the central beams of the projector and the camera by tangent of the angle of triangulation between the central beam of the projector and the central beam of the camera.

4. The method of claim 1, wherein it additionally registers a light reflected from the object by at least one additional improving camera, and the first camera and the improving camera are installed at different distances from the projector with formation of different triangulation angles between the central beam of the projector and central beams of the cameras, and an improvement of the vertical coordinate is performed, wherein the method uses a value of the vertical coordinate obtained by the improved camera positioned under the triangulation angle larger than the first camera, wherein in order to achieve his, locations of same geometric elements are identified on an improving camera image, being closest to the longitudinal coordinates calculated as a product of said vertical coordinates defined by the first camera by tangent of the angle of triangulation the of the improving camera, and after that, improved values of the longitudinal and vertical coordinates are determined for these geometric elements.

5. The method of claim 4, wherein the light reflected by the object is additionally recorded by two additional improving cameras.

6. The method of claim 4, wherein the cameras are positioned on a same side of the projector.

7. The method of claim 4, wherein the cameras are positioned on both sides of the projector.

8. The method of claim 6, wherein it includes additional recording of an object's texture with an additional color camera, wherein the image received from this camera is displayed at a screen with overlaying of a three-dimensional polygon mesh obtained by a calculation based on light reflected by the object and recorded by the first camera and improvement by at least one improving camera.

9. The method of claim 1, wherein the measurement and determination of the coordinates and image of a three-dimensional polygonal mesh are produced with an additional computer, where a 3D image is displayed on a computer screen.

10. The method of claim 1, wherein a transmission of measurements is performed by means of additional means of wireless communication, including: Bluetooth, Wi-Fi, NFC.
